(19) United States
(12) Patent Application Publication
(10) Pub. No.: US 2020/0217409 A1
(43) Pub. Date: Jul. 9, 2020

(54) Isolator

(71) Applicant: GATES CORPORATION, Denver, CO (US)

(72) Inventors: Peter Ward, Farmington Hills, MI (US); Patricio De La Torre, Auburn Hills, MI (US)

(21) Appl. No.: 16/243,704

(22) Filed: Jan. 9, 2019

(51) Int. Cl. F16H 55/36; F16F 15/121

(52) U.S. Cl. CPC F16H 55/36; F16H 2055/366; F16F 15/1216

(57) ABSTRACT

An isolator comprising a shaft, a pulley journalled to the shaft, a first torsion spring engaged between the shaft and the pulley, a second torsion spring engaged between the shaft and the pulley, the first torsion spring and the second torsion spring wound in opposite directions, the first torsion spring engaged to transmit a first torque in a first direction from the pulley to the shaft, the second torsion spring having a passive engagement with the pulley during transmission of the first torque, and the second torsion spring engaged to transmit a second torque in a second direction from the shaft to the pulley, the first torsion spring having a passive engagement with the pulley during transmission of the second torque.

### FIELD OF THE INVENTION

The invention relates to an isolator, and more particularly, to an isolator having a first torsion spring engaged to transmit a first torque in a first direction from a pulley to a shaft, a second torsion spring having a passive engagement with the pulley during transmission of the first torque, and the second torsion spring engaged to transmit a second torque in a second direction from the shaft to the pulley, the first torsion spring having a passive engagement with the pulley during transmission of the second torque.

### BACKGROUND OF THE INVENTION

It is known that providing a device with an elastic element between the crankshaft of the engine and a belt driven accessory such as a motor generator reduces the load on the belt. The device can absorb the speed fluctuations that are a result of the torsional vibration caused by a firing engine. The benefits from reduced load can include the following: reduced peak dynamic tension, reduced installation tension, reduced span vibration, and reduced belt slip. All of the aforementioned benefits also contribute to another benefit of reduced parasitic power losses that can reduce fuel consumption and emissions.

Representative of the art is US patent publication number 20180087599 which discloses an isolator for isolating a device driven by an engine via an endless drive member. The isolator includes a shaft adapter that is connectable with a shaft of the device and that defines an isolator axis, a rotary drive member that is engageable with the endless drive member, a first isolation spring arrangement that includes a first torsion spring, and that is positioned to transfer torque between the shaft adapter and an intermediate drive member, and a second isolation spring arrangement that is positioned to transfer torque between the intermediate member and the rotary drive member.

What is needed is an isolator having a first torsion spring engaged to transmit a first torque in a first direction from a pulley to a shaft, a second torsion spring having a passive engagement with the pulley during transmission of the first torque, and the second torsion spring engaged to transmit a second torque in a second direction from the shaft to the pulley, the first torsion spring having a passive engagement with the pulley during transmission of the second torque. The present invention meets this need.

### SUMMARY OF THE INVENTION

The primary aspect of the invention is an isolator having a first torsion spring engaged to transmit a first torque in a first direction from a pulley to a shaft, a second torsion spring having a passive engagement with the pulley during transmission of the first torque, and the second torsion spring engaged to transmit a second torque in a second direction from the shaft to the pulley, the first torsion spring having a passive engagement with the pulley during transmission of the second torque.

Other aspects of the invention will be pointed out or made obvious by the following description of the invention and the accompanying drawings.

The invention comprises an isolator comprising a shaft, a pulley journalled to the shaft, a first torsion spring engaged between the shaft and the pulley, a second torsion spring engaged between the shaft and the pulley, the first torsion spring and the second torsion spring wound in opposite directions, the first torsion spring engaged to transmit a first torque in a first direction from the pulley to the shaft, the second torsion spring having a passive engagement with the pulley during transmission of the first torque, and the second torsion spring engaged to transmit a second torque in a second direction from the shaft to the pulley, the first torsion spring having a passive engagement with the pulley during transmission of the second torque.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a cross-section view.

FIG. 2 is an exploded view.

FIG. 3 is a perspective detail of the shaft.

FIG. 4 is a perspective detail of the shaft.

FIG. 5 is a perspective detail of the cover.

FIG. 6 is a cross-section view of an alternate embodiment.

FIG. 7 is an exploded view of the alternate embodiment.

FIG. 8 is a perspective view of the alternate embodiment sprocket.

FIG. 9 is a perspective view of the alternate embodiment shaft.

FIG. 10 is a partial cut away perspective view of the alternate embodiment.

FIG. 11 is a partial cut away perspective view of the alternate embodiment.

FIG. 12 is a chart showing a characterization of the device.

### DETAILED DESCRIPTION OF THE PREFERRED EMBODIMENT

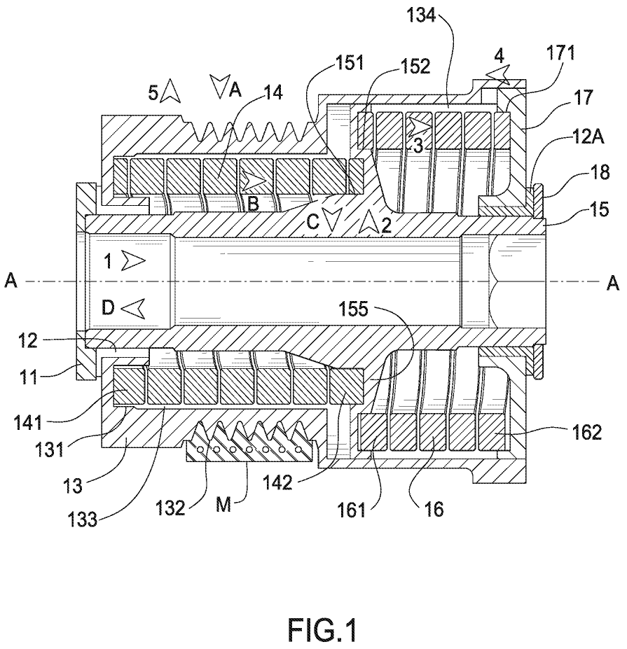

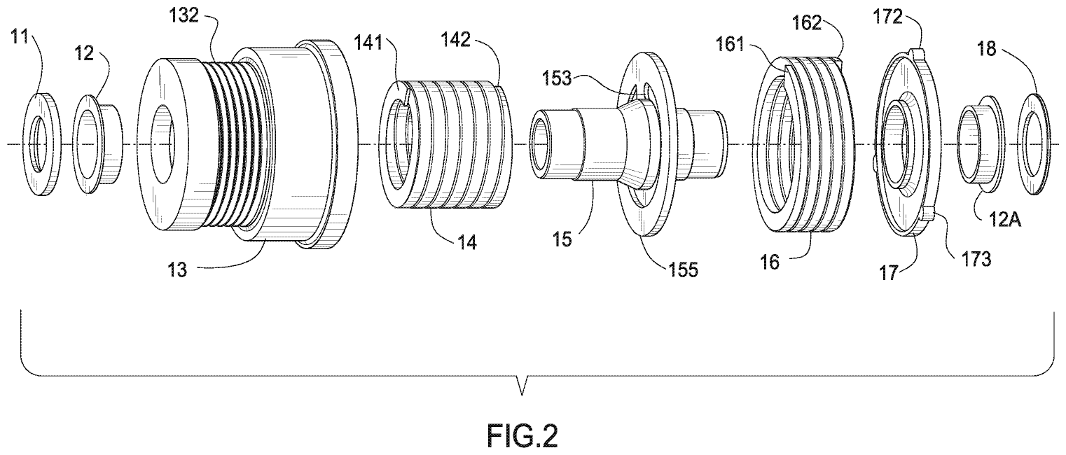

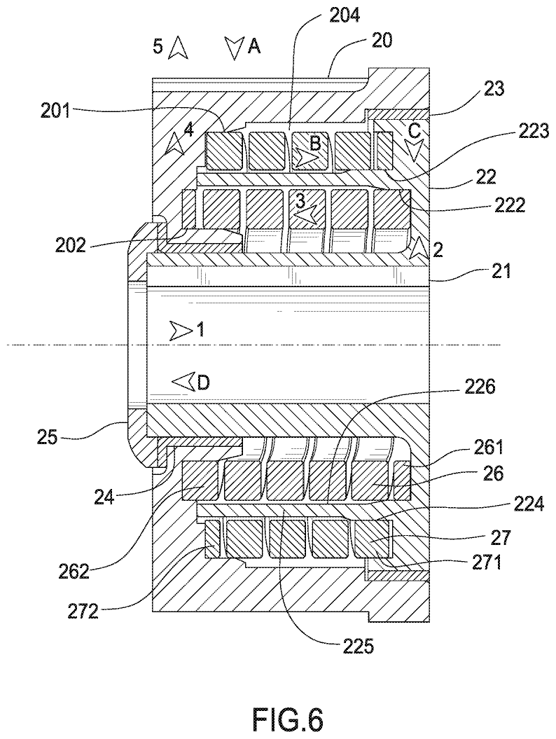

FIG. 1 is a cross-section view. This embodiment is configured for use with use with a multi-ribbed belt. Multi-ribbed belts are common for certain hybrid configurations. FIG. 6 shows an alternate arrangement for another hybrid configuration using a toothed or synchronous belt. The inventive device can be used either as a driver or driven component depending on the hybrid system operational condition.

The inventive device comprises a shaft 15. Shaft 15 comprises a radially extending flange 155. Flange 155 comprises pocket 153 and pocket 154. Cover 17 is press fit into an end of pulley 13. Cover 17 is journalled to shaft 15 on bushing 12a. Another end of pulley 13 is journalled to shaft 15 on bushing 12. Bushing 12 and bushing 12a allow relative rotational motion between pulley 13 and shaft 15. Load spreader 11 and washer 18 are press fit to respective ends of shaft 15 to hold pulley 13 axially in position. Pulley 13 engages a multi-ribbed belt (M) at surface 132.

Torsion spring 14 is disposed between pulley 13 and flange 155. Torsion spring 16 is disposed between flange 155 and cover 17. End 141 of spring 14 is in frictional contact with inner surface 131 of pulley 13. End 142 engages and urges upon pocket 153 of flange 155 to drive shaft 15. End 161 of spring 16 engages and urges upon pocket 154 of flange 155. End 162 of spring 16 has a sliding engagement with surface 171 of cover 17. Torsion spring 14 and torsion spring 16 are each wound in opposite directions. Torsion springs 14 and 16 extend axially along axis A-A in opposite directions from flange 155.

FIG. 1 illustrates the power flow for both driven and driver conditions.

Driven Condition.

In the driven condition where a belt drives pulley 13, spring 14 provides vibration attenuation by absorbing belt drive speed fluctuations. These can be caused by firing impulses of an IC engine.

Torque applied to pulley 13 by a belt, Arrow A, causes spring 14 to unwind to thereby create a torque transmitting coupling between pulley 13 and spring 14, Arrow B. Torque then flows to flange 155 and shaft 15, Arrow C. Torque flows from shaft 15 to a driven device, Arrow D, attached to shaft 15 such as a motor generator unit (MGU) (not shown). MGU's are known in the hybrid vehicle arts.

Between end 141 and end 142, spring 14 coils rotationally displace which allows pulley 13 to partially advance ahead of shaft 15 in the driven direction. The spring characteristic allows spring 14 to absorb speed fluctuations caused by the belt. Inner surface 133 of pulley 13 acts as stop to prevent spring 14 from overstress because surface 133 prevents spring 14 from excessively unwinding. Unwinding of spring 14 causes the coils to expand radially and thereby engage surface 133.

In this driven condition spring 16 is in overrun and end 162 slips on surface 171 of cover 17, in effect spring becomes passive and does not participate in power transfer. Spring 16 is wound onto surface 152 so that spring 16 rotates with shaft 15.

Driver Condition.

In the driver condition, spring 16 provides vibration attenuation by absorbing belt drive speed fluctuations. In the driver condition shaft 15 is attached to and driven by an MGU. Pocket 154 of flange 155 engages and drives end 161 of spring 16. Between end 161 and end 162 the active coils of spring 16 enable shaft 15 to advance rotationally ahead of pulley 13. End 162 is in frictional contact with surface 171 of cover 17. As spring 16 unwinds and bears upon surface 171, it drives cover 17. Cover 17 is mechanically coupled or otherwise press fit to pulley 13 through tabs 172, 173, and 174. Tabs 172, 173 and 174 extend radially from an outer circumference of cover 17. Inner surface 134 of pulley 13 acts as stop to prevent spring 16 from overstress since surface 134 prevents spring 16 from unwinding. Unwinding of spring 16 causes the coils to expand radially and thereby engage surface 134.

In this driver condition spring 14 is in overrun. End 141 slips on surface 131 of pulley 13, in effect spring 14 becomes passive. End 142 winds onto surface 151, thereby gripping surface 151 so that spring 14 rotates with shaft 15.

Torque applied to shaft 15, Arrow 1, causes spring 16 to wind to create a torque transmitting coupling between shaft 15 and cover 17, Arrow 2 and Arrow 3. Torque then flows to pulley 13 through the connection to cover 17, Arrow 4. Torque flows from pulley 13 through a belt (not shown) to a driven device, Arrow 5, for example, an accessory drive system on an IC engine (not shown).

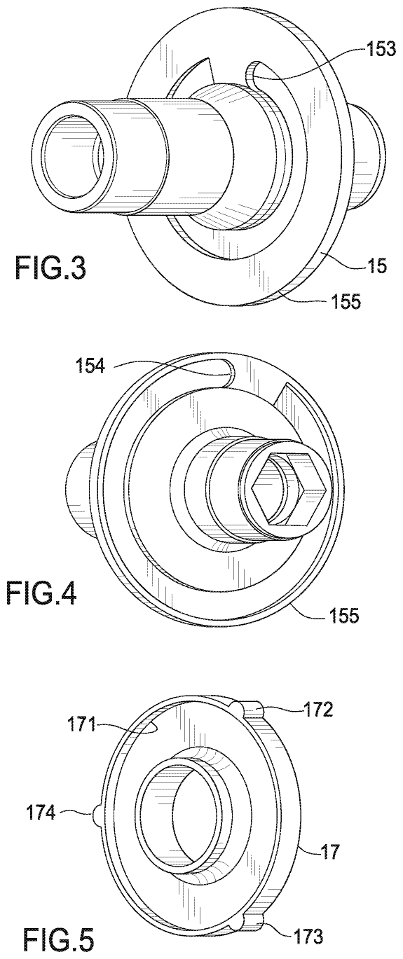

FIG. 3 is a perspective detail of the shaft. Flange 155 extends radially from shaft 15. Pocket 153 is disposed on a side of flange 155.

FIG. 4 is a perspective detail of the shaft. Pocket 154 is disposed on a side opposite that of pocket 153.

FIG. 5 is a perspective detail of the cover. Tabs 172, 173 and 174 engage pulley 13 and extend radially from an outer circumference of cover 17. Inner surface 171 engages spring end 162.

FIG. 6 is a cross-section view of an alternate embodiment. This alternate embodiment is used in a system with a toothed belt.

Sprocket 20 is journalled to shaft 21 through bushing 24. Retainer 25 holds bushing 24 in place on shaft 21. The other end of sprocket 20 is journalled to shaft flange 22 by bushing 23. A toothed belt engages surface 203.

Torsion spring 26 is engaged between flange 22 and sprocket 20. Torsion spring 27 is engaged between sprocket and flange 22. End 261 of spring 26 engages inner surface 222. End 262 of spring 26 engages pocket 202. End 271 of spring 27 engages pocket 221. End 272 of spring 27 engages inner surface 201 of sprocket 20. Torsion spring 26 and torsion spring 27 are wound in opposite directions. In this embodiment torsion spring 26 and torsion spring 27 extend along axis A-A in the same direction from flange 22.

Driven Condition Alternate Embodiment.

In the driven condition a toothed belt drives sprocket 20. Spring 26 provides vibration attenuation by absorbing belt drive speed fluctuations. End 272 of spring 27 is in frictional contact with inner surface 201 of sprocket 20. Torque applied to sprocket 20 causes spring 27 to unwind thereby transmitting torque between sprocket 20 and spring 27. Spring 27 radially expands as it unwinds, thereby frictionally engaging surface 201.

End 271 urges upon pocket 221 of flange 22 to drive shaft 21. The spring coils between end 272 and end 271 rotationally displace to allow sprocket 20 to advance rotationally ahead of shaft 21 to absorb belt speed fluctuations. Inner surface 204 of sprocket 20 acts as stop to prevent spring 24 from being overstressed by radially over-expanding. While in the driven condition spring 26 is in overrun and end 261 slips on inner surface 222 of flange 22, in effect spring 26 becomes passive. Spring 26 is wound onto surface 202 so spring 26 rotates with sprocket 20. Cylindrical portion 225 extends in an axial direction from flange 22.

In the driven condition torque flow is from a toothed belt to sprocket 20, Arrow A, through spring 27, Arrow B, to flange 22, Arrow C. Torque then flows to shaft 21 and on to a driven component, Arrow D, such as an MGU (not shown).

Driver Condition Alternate Embodiment.

When the device is the driver of a toothed belt, spring 26 provides vibration attenuation by absorbing belt drive speed fluctuations. Shaft 21 is driven by an MGU. End 261 of spring 26 is in frictional contact with inner surface 222 of flange 22. Spring 26 is driven in the unwinding direction as it drives sprocket 20. End 262 engages pocket 202. Inner surface 226 of cylindrical portion 225 restricts radial displacement of spring 26 to prevent spring 26 from overstress through uncontrolled radial expansion. Between end 261 and end 262 the active coils of spring 26 enable shaft 21 to advance rotationally ahead of sprocket 20.

In this driver condition spring 27 is in overrun. End 272 slips on inner surface 201 of sprocket 20, in effect spring 27 becomes passive. End 271 is wound onto inner surface 224 so spring 27 rotates with shaft 21.

In the driver condition torque flow is from shaft 21, Arrow 1, to flange 22, Arrow 2, through spring 26, Arrow 3, to sprocket 20, Arrow 4. Torque then flows from sprocket 20 to a toothed belt, Arrow 5.

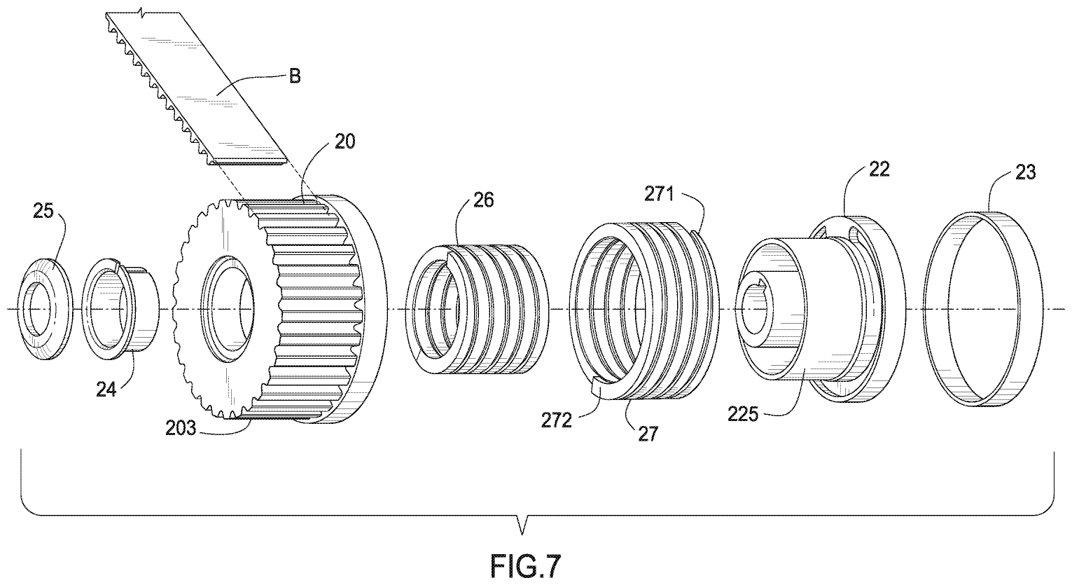

FIG. 7 is an exploded view of the alternate embodiment. Spring 26 is radially disposed within spring 27. A toothed belt B engages toothed surface 203.

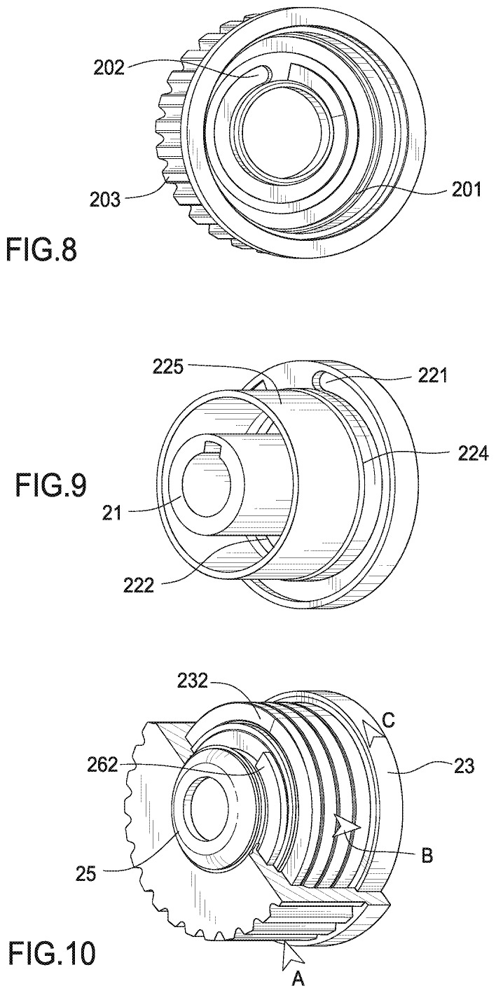

FIG. 8 is a perspective view of the sprocket. Pocket 202 of sprocket 20 engages end 262 of spring 26. Surface 201 engages end 272 of spring 27.

FIG. 9 is a perspective view of the shaft. Pocket 221 engages end 271 of spring 27. Inner surface 222 of cylindrical portion 225 engages end 261 of spring 26.

FIG. 10 is a partial cut away perspective view of the alternate embodiment. Arrows A, B and C show torque flow in the driven condition.

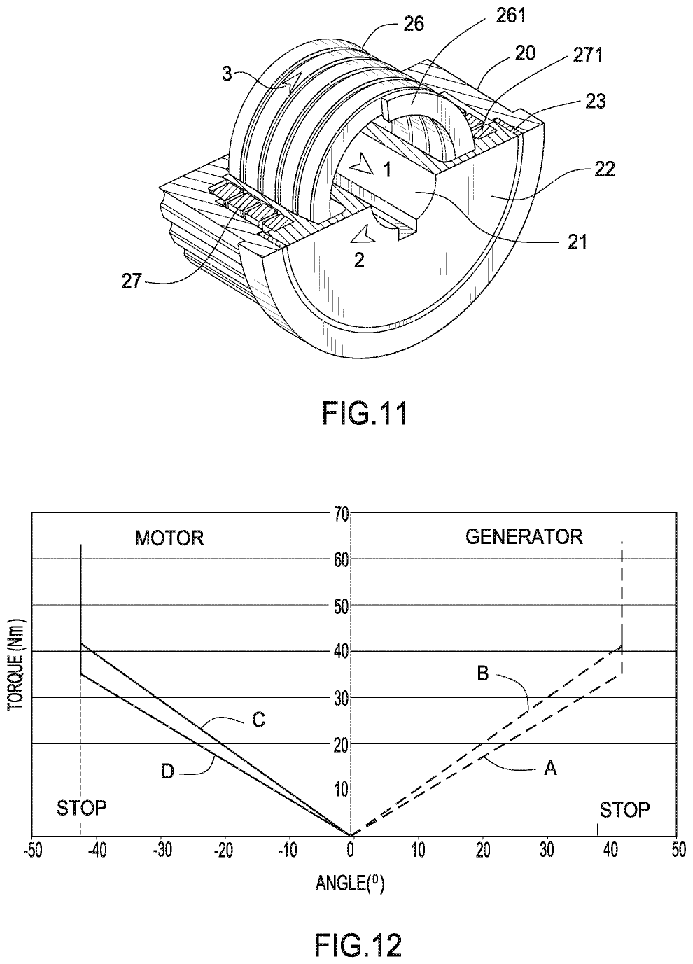

FIG. 11 is a partial cut away perspective view of the alternate embodiment. Spring 26 and spring 27 are each contained within an axial length of sprocket 20, thereby resulting in a minimal length for the device, which in turn reduces an engine size envelope. Sprocket 20 is approximately the same width as a toothed belt, for example, approximately 25 mm to 30 mm.

FIG. 12 is a chart showing a characterization of the device. FIG. 12 depicts use of the device on an MGU in the generator function and motor function. Lines A and B indicate the loading and unloading when the MGU is being used as a generator. Lines C and D indicate the loading and unloading when the MGU is being used as a motor. Angular displacement as a function of torque shows the linear and repeatable behavior of the device in either mode.

An isolator comprising a shaft, a pulley journalled to the shaft, a first torsion spring engaged between the shaft and the pulley, a second torsion spring engaged between the shaft and the pulley, the first torsion spring and the second torsion spring wound in opposite directions, the first torsion spring engaged to transmit a first torque in a first direction from the pulley to the shaft, the second torsion spring having a passive engagement with the pulley during transmission of the first torque, and the second torsion spring engaged to transmit a second torque in a second direction from the shaft to the pulley, the first torsion spring having a passive engagement with the pulley during transmission of the second torque.

An isolator comprising a shaft, a pulley journalled to the shaft, a first torsion spring engaged between the shaft and the pulley, a second torsion spring engaged between the shaft and the pulley, the first torsion spring and the second torsion spring wound in opposite directions, the shaft comprises a radial flange for engaging the first torsion spring and the second torsion spring, the first torsion spring and the second torsion spring extend axially from the radial flange, the first torsion spring engaged to transmit a first torque in a first direction from the pulley to the shaft, the second torsion spring having a passive engagement with the pulley during transmission of the first torque, and the second torsion spring engaged to transmit a second torque in a second direction from the shaft to the pulley, the first torsion spring having a passive engagement with the pulley during transmission of the second torque.

An isolator comprising a shaft, a pulley journalled to the shaft, a first torsion spring engaged between the shaft and the pulley, a second torsion spring engaged between the shaft and the pulley, the first torsion spring and the second torsion spring wound in opposite directions, the shaft comprises a radial flange for engaging the first torsion spring and the second torsion spring, the first torsion spring and the second torsion spring extend axially from the radial flange, the first torsion spring engaged to transmit a first torque in a first direction from the pulley to the shaft, the second torsion spring having a passive engagement with the pulley during transmission of the first torque, the first torsion spring loaded in the unwinding direction when transmitting the first torque, and the second torsion spring engaged to transmit a second torque in a second direction from the shaft to the pulley, the first torsion spring having a passive engagement with the pulley during transmission of the second torque, the second torsion spring loaded in the unwinding direction when transmitting the second torque.

Although forms of the invention have been described herein, it will be obvious to those skilled in the art that variations may be made in the construction and relation of parts without departing from the spirit and scope of the invention described herein. Unless otherwise specifically noted, components depicted in the drawings are not drawn to scale. Further, it is not intended that any of the appended claims or claim elements invoke 35 U.S.C. § 112(f) unless the words “means for” or “step for” are explicitly used in the particular claim. The present disclosure should in no way be limited to the exemplary embodiments or numerical dimensions illustrated in the drawings and described herein.

We claim:

1. An isolator comprising:
a shaft;
a pulley journalled to the shaft;
a first torsion spring engaged between the shaft and the pulley;
a second torsion spring engaged between the shaft and the pulley;
the first torsion spring and the second torsion spring wound in opposite directions;
the first torsion spring engaged to transmit a first torque in a first direction from the pulley to the shaft, the second torsion spring having a passive engagement with the pulley during transmission of the first torque; and
the second torsion spring engaged to transmit a second torque in a second direction from the shaft to the pulley, the first torsion spring having a passive engagement with the pulley during transmission of the second torque.

2. The isolator in claim 1, wherein the shaft comprises a radial flange for engaging the first torsion spring and the second torsion spring.

3. The isolator in claim 2, wherein the first torsion spring and the second torsion spring extend axially in opposite directions from the radial flange.

4. The isolator as in claim 2, wherein the first torsion spring and the second torsion spring extend axially in the same direction from the radial flange.

5. The isolator as in claim 1, wherein the first torsion spring is loaded in the unwinding direction when transmitting the first torque.

6. The isolator as in claim 1, wherein the second torsion spring is loaded in the unwinding direction when transmitting the second torque.

7. The isolator as in claim 1, wherein the first torsion spring passive engagement is a sliding engagement.

8. The isolator as in claim 1, wherein the second torsion spring passive engagement is a sliding engagement.

9. An isolator comprising:
a shaft;
a pulley journalled to the shaft;
a first torsion spring engaged between the shaft and the pulley;
a second torsion spring engaged between the shaft and the pulley;
the first torsion spring and the second torsion spring wound in opposite directions;
the shaft comprises a radial flange for engaging the first torsion spring and the second torsion spring, the first torsion spring and the second torsion spring extend axially from the radial flange;
the first torsion spring engaged to transmit a first torque in a first direction from the pulley to the shaft, the second torsion spring having a passive engagement with the pulley during transmission of the first torque; and
the second torsion spring engaged to transmit a second torque in a second direction from the shaft to the pulley, the first torsion spring having a passive engagement with the pulley during transmission of the second torque.

10. An isolator comprising:
a shaft;
a pulley journalled to the shaft;
a first torsion spring engaged between the shaft and the pulley;
a second torsion spring engaged between the shaft and the pulley;
the first torsion spring and the second torsion spring wound in opposite directions;
the shaft comprises a radial flange for engaging the first torsion spring and the second torsion spring, the first torsion spring and the second torsion spring extend axially from the radial flange;
the first torsion spring engaged to transmit a first torque in a first direction from the pulley to the shaft, the second torsion spring having a passive engagement with the pulley during transmission of the first torque, the first torsion spring loaded in the unwinding direction when transmitting the first torque; and
the second torsion spring engaged to transmit a second torque in a second direction from the shaft to the pulley, the first torsion spring having a passive engagement with the pulley during transmission of the second torque, the second torsion spring loaded in the unwinding direction when transmitting the second torque.
